(19) United States
(12) Patent Application Publication
(10) Pub. No.: US 2015/0080180 A1
(43) Pub. Date: Mar. 19, 2015

(54) Method for Synchronizing a Form-Fitting Shifting Element in a Gearshift in Overrun Operation with Positive Motor Intervention or Positive Speed Guidance

(71) Applicant: ZF Friedrichshafen AG, Friedrichshafen (DE)

(72) Inventor: Christoph Hess, Eriskirch (DE)

(21) Appl. No.: 14/484,788

(22) Filed: Sep. 12, 2014

(30) Foreign Application Priority Data
Sep. 13, 2013 (DE) 10 2013 218 365.8

(51) Int. Cl. F16H 61/02; B60W 10/11; B60W 10/06

(52) U.S. Cl. CPC F16H 61/0213; B60W 10/06; B60W 10/11
USPC 477/115

(57) ABSTRACT

Within the framework of the method for implementing the synchronization of a positive-locking shifting element for a gearshift in thrust mode with a positive engine control intervention or a positive rotational speed control, the input signal for the transmission control for the traction-thrust detection is switched over to traction, such that the gearshift in the transmission control proceeds as a gearshift in traction mode.

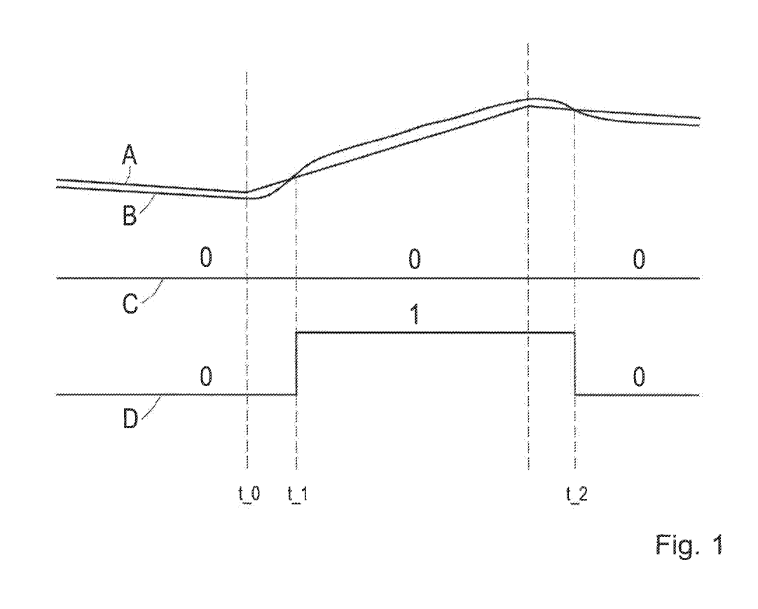

The present invention relates to a method for implementing the synchronization of a positive-locking shifting element for a gearshift in thrust mode with a positive engine control intervention or a positive rotational speed control in accordance with the preamble of patent claim 1.

It is known from the state of the art, to actively synchronize the positive-locking shifting element for a gearshift in thrust mode, i.e., to bring the rotational speed in the direction of a synchronous rotational speed by means of a positive engine control intervention or by means of a positive rotational speed control. By doing so, the gearshift is accelerated, and comfort for the driver is increased. In addition, the wear on the participating positive-locking shifting elements is reduced.

In the transmission control, according to the state of the art, such gearshifts in thrust mode with a positive engine control intervention or with a positive rotational speed control proceed as thrust gearshifts, but this has negative effects on shifting comfort.

Thereby, according to the state of the art, for the detection of a thrust or traction mode, a torque signal is evaluated, for which, in a disadvantageous manner, a positive engine control intervention or a positive rotational speed control is not displayed, and an input signal for the traction-thrust detection is generated. This has the consequence that thrust gearshifts with a positive engine control intervention or a positive rotational speed control are functionally treated as thrust gearshifts, although such gearshifts proceed as physically viewed in traction mode.

Thereby, the gearshift process is negatively affected in terms of comfort. For example, the target differential rotational speed is generated on the basis of the input signal for the traction-thrust detection, such that a gearshift proceeding in thrust mode with a positive engine control intervention proceeds with a positive differential rotational speed, whereas, according to the state of the art, the target differential rotational speed is negative, since, as already explained, a thrust gearshift is detected. The result is a significant deviation in the differential rotational speed, and the converter clutch controller reacts with a reduction in pressure, such that, as a result of this incorrect reaction, shifting comfort is negatively impacted.

The present invention is subject to the task of specifying a method for implementing the synchronization of a positive-locking shifting element for a gearshift in thrust mode with a positive engine control intervention or a positive rotational speed control, through the implementation of which the disadvantages known from the state of the art are avoided. In particular, shifting comfort in the event of a gearshift of a positive-locking shifting element in thrust mode with a positive engine control intervention or a positive rotational speed control is to increase.

This task is solved by the characteristics of claim 1. Additional arrangements and advantages under the invention arise from the sub-claims.

Accordingly, a method for implementing the synchronization of a positive-locking shifting element for a gearshift in thrust mode with a positive engine control intervention or a positive rotational speed control is proposed, within the framework of which the input signal for the transmission control for the traction-thrust detection is switched over to traction, such that such gearshifts in the transmission control proceed as gearshifts in traction mode.

For example, the input signal for the transmission control for the traction-thrust detection may be switched over to traction at the point in time at which the rotational speed of the engine exceeds the rotational speed of the turbine. If the rotational speed of the engine drops below the rotational speed of the turbine, the input signal for the traction-thrust detection is again switched over to thrust.

Within the framework of one arrangement of the method in accordance with the invention, the input signal for the traction-thrust detection for such gearshifts, i.e. for gearshifts in thrust mode with a positive engine control intervention or a positive rotational speed control, is hard-coded. This means that, for certain, predetermined gearshifts, for example a downshift from fifth into the fourth forward gear, the input signal for the traction-thrust detection is defined in advance.

In addition, the input signal for the traction-thrust detection can be applied or selected for each gearshift in a vehicle transmission, whereas the input signal is also able to be selected outside of gearshifts for each gear. For example, the input signal may be coded through a table that is stored in the transmission software. In this manner, a change to the input signal may take place for an upcoming gearshift in thrust mode with a positive engine control intervention, in order to, as already explained, increase shifting comfort.

The detection of upcoming engine control intervention may occur by means of evaluating the signals of control units of the transmission that affect the engine torque.

In the following, the invention is more specifically described using the attached FIGURE, which presents the courses of the input signal for the transmission control for the traction-thrust detection upon a gearshift in thrust mode with a positive engine control intervention according to the state of the art and in accordance with the present invention, along with the courses of the rotational speed of the engine and the rotational speed of the turbine as a function of time for a gearshift in thrust mode with a positive engine control intervention.

In the attached FIGURE, curve A represents the course of the rotational speed of the turbine upon a gearshift in thrust mode with a positive engine control intervention as a function of time, whereas curve B represents the chronological course of the rotational speed of the engine upon a gearshift in thrust mode with a positive engine control intervention.

Curve C represents the course of the input signal for the traction-thrust detection according to the state of the art, whereas curve D represents the course of the input signal for the traction-thrust detection in accordance with the invention. Thereby, the value 0 corresponds to a thrust gearshift, and the value 1 corresponds to a traction gearshift. According to the state of the art, upon a gearshift in thrust mode with a positive engine control intervention, an input signal for the traction-thrust detection is generated; this corresponds to a detected thrust gearshift.

In accordance with the invention, upon a gearshift in thrust mode with a positive engine control intervention, the input signal for the traction-thrust detection is switched over such that the gearshift in the transmission control proceeds as a gearshift in traction mode.

As can be seen in the attached FIGURE, the gearshift is initiated at the point in time t_0, whereas the input signal for the traction-thrust detection at the point in time t_1, at which the rotational speed of the engine exceeds the rotational speed of the turbine, is switched over to the value 1. After the end of the synchronization of the positive-locking shifting element, if the rotational speed of the engine drops below the rotational speed of the turbine, the input signal for the traction-thrust detection is again switched over to the value 0, which for the example shown in the FIGURE takes place at the point in time t_2.

### REFERENCE SIGNS

A Course of the rotational speed of the turbine upon a gearshift in thrust mode with a positive engine control intervention as a function of time

B Chronological course of the rotational speed of the engine upon a gearshift in thrust mode with a positive engine control intervention

C Course of the input signal for the traction-thrust detection according to the state of the art

D Course of the input signal for the traction-thrust detection in accordance with the invention

t_0 Point in time of the initiation of the gearshift

t_1 Point in time of the switching over of the input signal for the traction-thrust detection to the value 1

t_2 Point in time of the switching over of the input signal for the traction-thrust detection to the value 0

1. Method for implementing the synchronization of a positive-locking shifting element for a gearshift in thrust mode with a positive engine control intervention or a positive rotational speed control, characterized in that the input signal for the transmission control for the traction-thrust detection is switched over to traction, such that the gearshift in the transmission control proceeds as a gearshift in traction mode.

2. Method for implementing the synchronization of a positive-locking shifting element for a gearshift in thrust mode with a positive engine control intervention or a positive rotational speed control according to claim 1, characterized in that the input signal for the traction-thrust detection can be applied for each gearshift in a vehicle transmission, whereas the input signal is also able to be selected outside of gearshifts for each gear.

3. Method for implementing the synchronization of a positive-locking shifting element for a gearshift in thrust mode with a positive engine control intervention or a positive rotational speed control according to claim 1, characterized in that the input signal for the traction-thrust detection is coded through a table that is stored in the transmission software.
